(19) United States
(12) Patent Application Publication
(10) Pub. No.: US 2007/0103337 A1
(43) Pub. Date: May 10, 2007

(54) Backup traffic control systems and methods

(75) Inventors: Chris Heam, St. Pete Beach, FL (US); Andrew W. Guyette, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/269,963

(22) Filed: Nov. 9, 2005

(51) Int. Cl. G08G 1/095; G08B 23/00

(52) U.S. Cl. 340/907; 340/693.3; 340/693.2

(57) ABSTRACT

System and methods for traffic control are provided. In one embodiment, a method for controlling traffic at an intersection of two or more roadways is provided. The method comprises sensing a power received from an external power source; when the power received is lower than a threshold value, periodically cycling power from a backup power source to one or more lamps; illuminating the one or more lamps; and controlling traffic based on the one or more lamps.

### TECHNICAL FIELD

The present invention generally relates to traffic control devices and more specifically to backup traffic control devices.

### BACKGROUND

In the aftermath of major storms, traffic control devices often do not operate because of the loss of electric power to the traffic control devices. This causes confusions on the roadway, adding to the dangers during and after a storm. Often, drivers that approach an intersection with a non-functioning traffic control device are unaware of laws that require the driver to stop at the intersection and treat the non-functioning traffic control device as an all-way stop sign. The resulting confusion can lead to traffic accidents.

For the reasons stated above and for other reasons stated below which will become apparent to those skilled in the art upon reading and understanding the specification, there is a need in the art for backup traffic control systems and methods.

### SUMMARY

The Embodiments of the present invention provide methods and systems for backup traffic control systems and methods and will be understood by reading and studying the following specification.

In one embodiment, a traffic control device is provided. The device comprises a sensing circuit adapted to sense a voltage level of power received from a primary power source and output a low power signal when the voltage level drops below a threshold value; a rechargeable backup power supply adapted to store electrical power; at least one lamp coupled to receive power from the rechargeable backup power supply; at least one switch coupled to switch power between the rechargeable backup power supply and the at least one lamp; and a timer adapted to receive the low power signal and generate a cyclical voltage output based on the low power signal, wherein the at least one switch is adapted to receive the cyclical voltage output and cycle the power between the rechargeable backup power supply and the at least one lamp on and off based on the cyclical voltage output.

In another embodiment, a method for controlling traffic at an intersection of two or more roadways is provided. The method comprises sensing a power received from an external power source; when the power received is lower than a threshold value, periodically cycling power from a backup power source to one or more lamps; illuminating the one or more lamps; and controlling traffic based on the one or more lamps.

In yet another embodiment, a system for controlling traffic at an intersection of two or more roadways. The system comprises means for storing electric power; means for charging the means for storing electric power; means for sensing a power received from an external power source; means for illumination, the means for illumination powered from the means for storing electric power; means for cycling the means for illumination on and off, the means for cycling responsive to the means for sensing.

### DRAWINGS

Embodiments of the present invention can be more easily understood and further advantages and uses thereof more readily apparent, when considered in view of the description of the preferred embodiments and the following figures in which:

FIG. 1 is a block diagram illustrating a traffic control system of one embodiment of the present invention;

FIG. 2 is a block diagram illustrating a rechargeable backup power supply of one embodiment of the present invention;

FIG. 3 is a diagram illustrating a timer and switch circuit of one embodiment of the present invention; and

FIG. 4 is a flow chart illustrating a method of one embodiment of the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide systems and methods to notify drivers to stop at intersections where the traffic control device has failed due to a loss of electric power. Embodiments of the present invention provide a backup power source and circuitry to implement a blinking red light in one or more directions of an intersection, upon loss of a primary power supply to the traffic control devices.

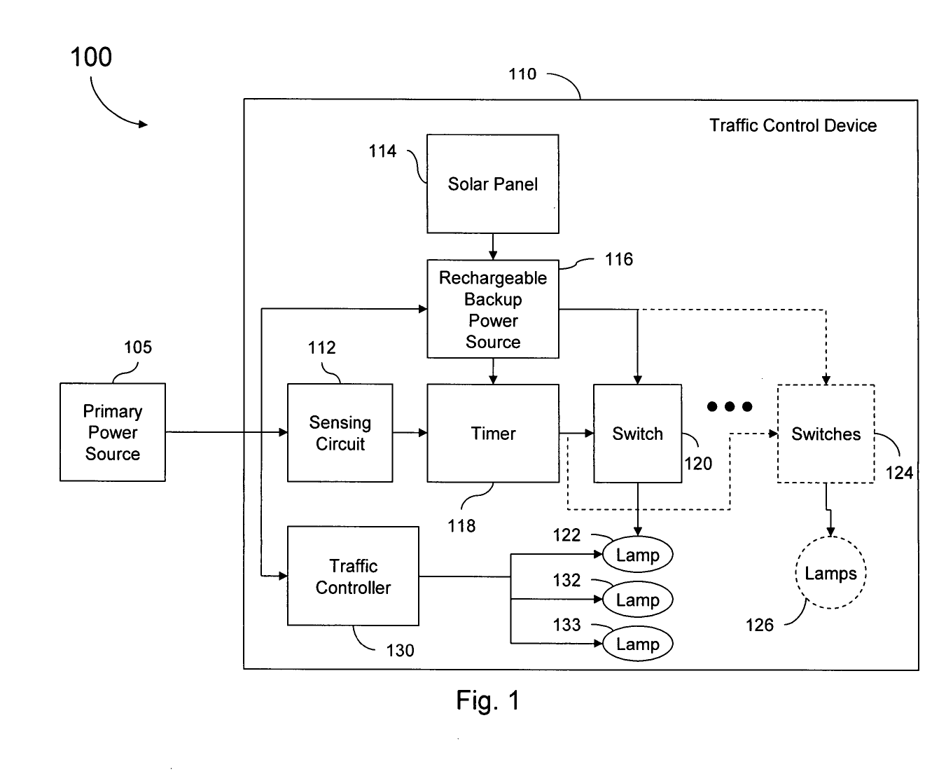

FIG. 1 is a block diagram illustrating a traffic control system 100 of one embodiment of the present invention. System 100 comprises a traffic control device 110 coupled to receive power from a primary power source 105. In one embodiment, primary power source 105 comprises one of an AC or DC electric power distribution system. In one embodiment, traffic control device 110 comprises a rechargeable backup power source 116 coupled to receive power from one or both of primary power source 105 and a solar panel 114. Traffic control device 110 further comprises a sensing circuit 112 coupled to monitor power received from primary power supply 105, a timer 118 coupled to receive a low power signal from sensing circuit 112 and power from rechargeable backup power source 116, and a switch 120 coupled to receive a flash signal from timer 118. Traffic control device 110 further comprises at least one lamp 122 coupled to receive switched power from rechargeable backup power source 116 through switch 120.

In one embodiment, during normal operations (i.e. when power is available from primary power source 105), lamp 122 receives electric power supplied by primary power source 105 and is controlled by traffic controller 130. In one embodiment during normal operations, when lamp 122 is a red lamp, traffic controller 130 additionally controls one or more of a green lamp 133 and a yellow lamp 132 in order to control the flow of traffic. In one embodiment, traffic controller 130 includes all the necessary circuitry, including passing of power from primary power source 105, for the normal operation of lamp 122, green lamp 133 and yellow lamp 132 to control traffic. In one embodiment, traffic controller 130 is one of any number of systems for controlling standard traffic light signals, as would be appreciated by one skilled in the art upon reading this specification.

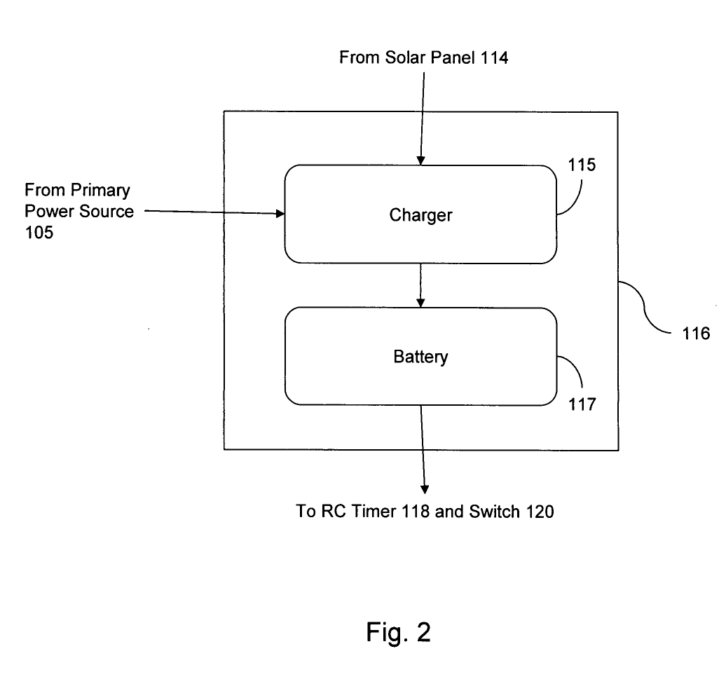

FIG. 2 illustrates a rechargeable backup power source 116 of one embodiment of the present invention. In one embodiment, rechargeable backup power source 116 comprises at least one battery 117 coupled to a charger 115. In one embodiment, during normal operations rechargeable backup power source 116 receives power from primary power source 105 to operate battery charger 115. Battery charger 115 in turn maintains the charge of battery 117.

In one embodiment, sensing circuit 112 monitors the power received by traffic control device 110 from primary power source 105. In one embodiment, when the voltage of electric power supplied by primary power source 105 drops below a predefined threshold, sensing circuit 112 outputs a low power signal to timer 118. In one embodiment, sensing circuit 112 comprises a voltage sensing relay, a voltage comparator, or similar power sensing device. Upon receiving the lower power signal, timer 118 cycles switch 120 periodically on and off, allowing current from battery 117 of rechargeable backup power source 115 to periodically flow to lamp 122. Thus, lamp 122 will appear to drivers as a flashing light. In one embodiment, when lamp 122 is a red lamp, the flashing of lamp 122 notifies drivers approaching the intersection to stop before proceeding. In one embodiment, traffic control device 110 further comprises one or more additional lamps 126 each of which flash on and off as directed by timer 118. In one embodiment, timer 118 further cycles one or more additional switches 124 on and off, allowing current from battery 117 of rechargeable backup power source 115 to periodically flow and illuminate additional lamps 126. In an alternate embodiment, additional lamps 126 receive power from rechargeable backup power source 115 via switch 120.

Although this specification uses the term “lamp” to describe lamp 122 and additional lamps 126, one skilled in the art would readily appreciate that “lamp” is not limited to an incandescent bulb, and encompasses any number of light emitting means now existing or developed in the future. For example, in one embodiment, one or both of lamp 122 and additional lamps 126 comprise one or more of, but not limited to, a neon light and an array of light emitting diodes. In one embodiment, solar panel 114 powers battery charger 115 to maintain the charge of battery 117 while traffic control device 110 operates during a loss of primary power source 105. In one embodiment, during normal operation, (i.e. when power from of primary power source 105 is available), solar panel 114 powers battery charger 115 to maintain a trickle charge to the rechargeable battery in order to assure proper operation during a power outage.

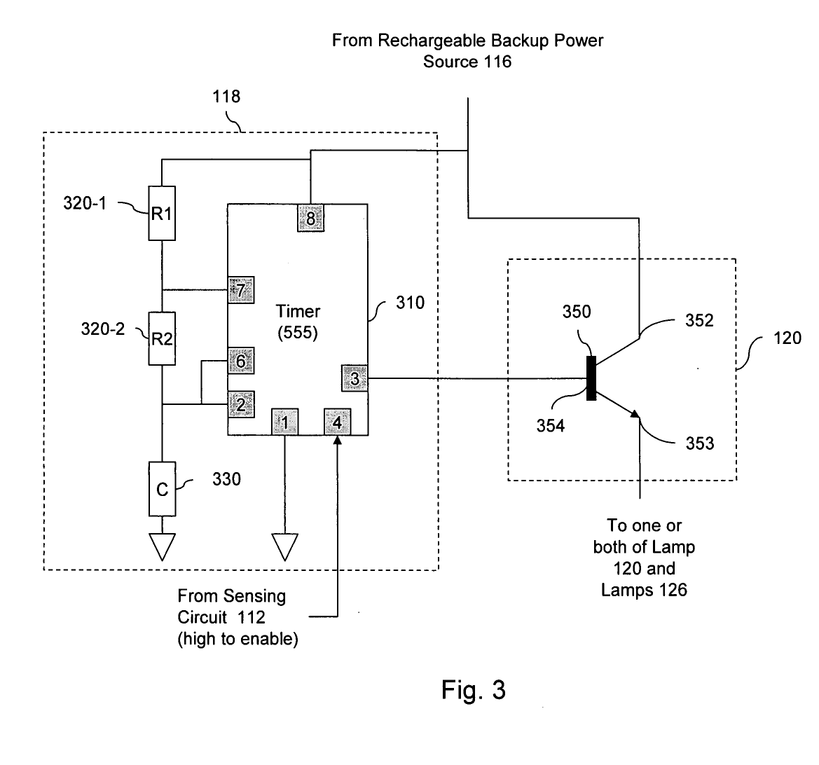

As would be appreciated by one skilled in the art upon reading this specification, there are numerous means to realize timer 118 and switch 120, of which this specification provides just an example. FIG. 3 illustrates a timer 118 coupled with a switch 120 of one embodiment of the present invention. In one embodiment, timer 118 is an RC timer comprising a timing device 310, resistors 320-1 (R1) and 320-2 (R2), and a capacitor 330 (C) coupled to timing device 310 as shown in FIG. 3. In one embodiment, timing device 310 is a 555 timer or similar device. In one embodiment, timing device 310 is powered by rechargeable backup power supply 116. In one embodiment, time device 310 outputs a cyclical voltage output with a period that is a function of the resistance of resistors 320-1 and 320-2 and the capacitance of capacitor 330. In one embodiment, switch 120 comprises a transistor 350 having a source 352 coupled to rechargeable backup power source 115, a drain 353 coupled to one or both of lamp 120 and additional lamps 126, and a gate 354 coupled to the output of timing device 310.

In operation, in one embodiment, when timing device 310 receives the low power signal from sensing circuit 112, timing device 310 outputs a cyclical voltage signal to gate 354 of transistor 350. In one embodiment, the low power signal comprises a logical high signal from sensing circuit 112. As the voltage at gate 354 rises, transistor 350 turns on and allows current to flow from battery 117 to one or both of lamp 120 and additional lamps 126, allowing them to illuminate. As the voltage at gate 354 falls, transistor 350 turns off and interrupts the current flow from battery 117 to one or both of lamp 120 and additional lamps 126, causing them to darken.

In one embodiment one or both of lamp 120 and additional lamps 126 comprise red lamps allowing traffic control device 110 to stop traffic in two or more directions. For example, in one embodiment, when traffic control device 110 controls traffic at a four-way intersection, lamp 120 comprises a red lamp and additional lamps 126 comprise three red lamps so that, upon a loss of primary power source 105, traffic control device 110 flashes red lamps in all four directions of the intersection. In one embodiment, one or more of lamp 122 and additional lamps 126 comprise at least one yellow lamp. For example, one embodiment, when traffic control device 110 controls traffic at a four-way intersection, upon a loss of primary power source 105, traffic control device 110 flashes two red lamps in to stop traffic flowing on a first roadway before entering the intersection, and flashes two yellow lamps to caution divers approaching the intersection on a second, intersecting roadway.

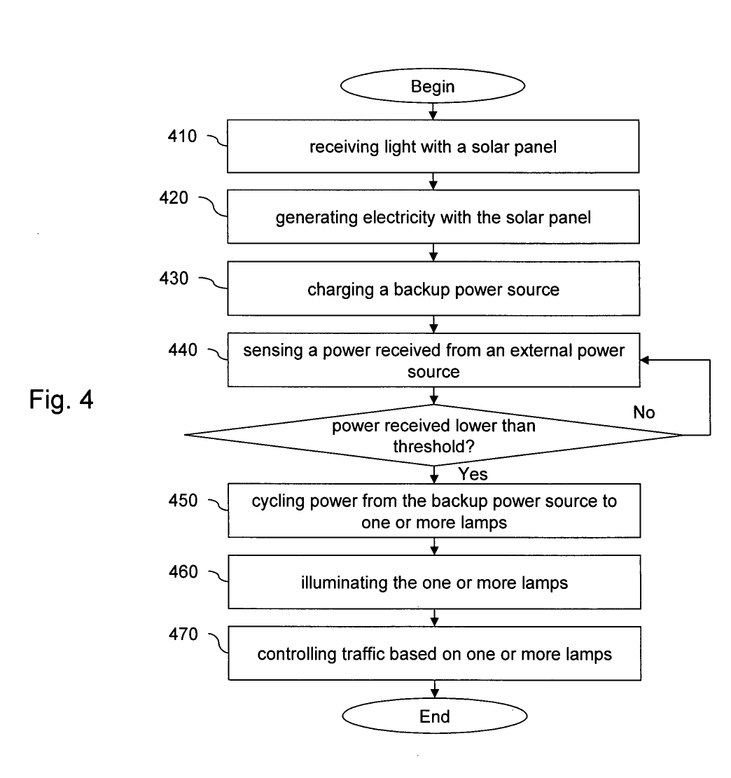

FIG. 4 is a flow chart illustrating a method for controlling traffic at an intersection of two or more roadways of one embedment of the present invention. In one embodiment, the method begins at 410 with receiving light with a solar panel. The solar panel generates electricity (420) which is used to charge a backup power source (430). In one embodiment, the backup power source comprises one or more batteries. The method further comprises sensing a power received from an external power source at 440. In one embodiment, the external power source provides the electric power required to operate a traffic control device, such as a typical red-yellow-green traffic light. In normal operation, the traffic control device regulates the flow of traffic through the intersection of two or more roadways. When the external power source is not available (e.g. due to loss of power from a storm), traffic control devices not adapted with embodiments of the present invention will go dark. Under these circumstances drivers approaching the intersection must rely on their knowledge of the law to remember that an out of service traffic control device should be regarded as a stop sign. Embodiments of the present invention relieve drivers of that burden by enabling a flashing red light at intersections that have lost external power. In one embodiment, the method proceeds to 450, when power received from the external power source is lower than a threshold value, and cycles power from the backup power source to one or more lamps, thus illuminating the one or more lamps (460) in a flashing manner.

As would be appreciated by one skilled in the art, the threshold value can be any arbitrary value less than a nominal power level usually provided by the external power source, which would indicate a fault or other instability affecting the supply of power from the external power source. In one embodiment, the threshold value is based on one or both of the voltage and frequency of the power received from the external power source.

With the one or more lamps flashing, the flow of traffic approaching the intersection is controlled (470) by alerting drivers of the need to stop before entering the intersection. In one embodiment, the flashing lamps include at least one red lamp flashing in the direction of traffic on a roadway approaching an intersection to notify drivers to stop before entering the intersection. In one embodiment, the flashing lamps include at least one yellow lamp flashing in the direction of traffic on a roadway approaching an intersection to notify drivers to proceed thought the intersection with caution.

As previously discussed above in this specification, there are a number of ways to cycle power from the backup power source to one or more lamps. In one embodiment, cycling power from the backup power source to one or more lamps further comprises generating a cyclical voltage output with a timer. In one embodiment, the timer may be optionally powered from the backup power source. The method then switches power from the backup power source to one or more lamps on and off based on the cyclical voltage output.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A traffic control device, the device comprising:
a sensing circuit adapted to sense a voltage level of power received from a primary power source and output a low power signal when the voltage level drops below a threshold value;
a rechargeable backup power source adapted to store electrical power;
at least one lamp coupled to receive power from the rechargeable backup power source;
at least one switch coupled to switch power between the rechargeable backup power source and the at least one lamp; and
a timer adapted to receive the low power signal and generate a cyclical voltage output based on the low power signal, wherein the at least one switch is adapted to receive the cyclical voltage output and cycle the power between the rechargeable backup power source and the at least one lamp on and off based on the cyclical voltage output.

2. The device of claim 1, further comprising:
a solar panel adapted to convert light into electrical power; and
wherein the rechargeable backup power source is coupled to the solar panel and adapted to store electrical power received from the solar panel.

3. The device of claim 1, wherein the at least one lamp comprises one or both of at least one red lamp and at least one yellow lamp.

4. The device of claim 1, wherein the at least one lamp comprises one or more of an incandescent lamp, a neon light, and a light emitting diode.

5. The device of claim 1, wherein the rechargeable backup power source further comprises:
a battery charger adapted to receive power from one or both of the primary power source and the solar panel;
a battery adapted to provide electric power to one or more of the timer, the at least one switch and the at least one lamp; and
wherein the battery charger is further adapted to maintain a charge of the battery.

6. The device of claim 1, wherein the timer further comprises a timing device adapted to cycle the at least one switch on and off based on the resistance of at least one resistor and the capacitance of at least one capacitor.

7. A method for controlling traffic at an intersection of two or more roadways, the method comprising:
sensing a power received from an external power source;
when the power received is lower than a threshold value, periodically cycling power from a backup power source to one or more lamps;
illuminating the one or more lamps; and
controlling traffic based on the one or more lamps.

8. The method of claim 7, wherein cycling power further comprises:
receiving light with a solar panel;
generating electricity with the solar panel; and
charging the backup power source with the electricity generated from the solar panel.

9. The method of claim 7, wherein cycling power further comprises:
powering a timer from the backup power source;
generating a cyclical voltage output with the timer; and
switching power from the backup power source to one or more lamps on and off based on the cyclical voltage output.

10. The method of claim 7, wherein illuminating one or more lamps further comprises illuminating one or more of an incandescent lamp, a neon light, and a light emitting diode.

11. The method of claim 7, wherein controlling traffic further comprises:
illuminating at least one red lamp of the one or more lamps in a cyclical manner in the direction of traffic on a roadway approaching an intersection.

12. The method of claim 7, wherein controlling traffic further comprises:
illuminating at least one yellow lamp of the one or more lamps in a cyclical manner in the direction of traffic on a roadway approaching an intersection.

13. A system for controlling traffic at an intersection of two or more roadways, the system comprising:
means for storing electric power;
means for charging the means for storing electric power;
means for sensing a power received from an external power source;
means for illumination, the means for illumination powered from the means for storing electric power;
means for cycling the means for illumination on and off, the means for cycling responsive to the means for sensing.

14. The system of claim 13 further comprising:
means for generating electric power from light; and
wherein the means for charging the means for storing electric power charges the means for storing electric power from power generated from the means for generating electric power from light.

15. The system of claim 13 further comprising:
means for comparing the sensed power against a threshold value, the means for comparing responsive to the means for sensing, wherein the means for cycling is further responsive to the means for comparing.

16. The system of claim 13, wherein the means for illumination further comprises one or more of an incandescent lighting means, a neon lighting means, a light emitting diode lighting means.

17. The system of claim 13, wherein the means for cycling further comprises:
means for generating a cyclical voltage output, the means for generating the cyclical voltage output responsive to the means for sensing; and
means for switching power from the means for storing electric power to the means for illumination on and off based on the cyclical voltage output, the means for switching responsive to the means for generating the cyclical voltage output.

18. The system of claim 17, wherein the means for generating the cyclical voltage output further comprises means for timing adapted to cycle the means for switching power.

19. The system of claim 18, wherein the means for timing cycles the means for switching power based on the resistance of at least one resistance means and the capacitance of at least one capacitance means.

20. The system of claim 13, wherein the means for illumination further comprises:
means for illuminating red light in a direction of traffic on a roadway approaching an intersection.

21. The system of claim 13, wherein controlling traffic further comprises:
means for illuminating yellow light in a direction of traffic on a roadway approaching an intersection.
